(19) United States
(12) Patent Application Publication
(10) Pub. No.: US 2008/0256835 A1
(43) Pub. Date: Oct. 23, 2008

(54) Letter And Number Segment Kit

(76) Inventor: Alexander Sloot, Sugarloaf, PA (US)

Correspondence Address: ST. ONGE STEWARD JOHNSTON & REENS, LLC, 986 BEDFORD STREET, STAMFORD, CT, 06905-5619, US

(21) Appl. No.: 11/737,376

(22) Filed: Apr. 19, 2007

(51) Int. Cl. G09F 7/16; G09B 1/00

(52) U.S. Cl. 40/595; 434/160

(57) ABSTRACT

A lettering and numbering kit including a plurality of a plurality of character segments is provided. The plurality of character segments have two different lengths and are shaped so as to form any number from 0-9 or any letter of the alphabet when so arranged in combination.

### FIELD OF THE INVENTION

The invention relates generally to identification letters and numbers, and more specifically to a lettering and numbering kit including a plurality of character segments for forming letters and numbers.

### BACKGROUND

Conventional lettering and numbering kits are widely used in the signage industry for identification and display purposes. These kits come in a variety of sizes, fonts, colors and materials for use in any number of different applications. For example, such numbering and lettering kits are often used to display messages on signs or storefront windows, to post addresses on homes, mailboxes, or office doors, or to identify goods, equipment or other personal belongings. Generally, these kits contain a full set of numbers and/or letters, with many duplicates, kiss-cut or die-cut into a self-adhesive vinyl sheet. These kits are convenient in that, within this one sheet, the user has at his or her disposal a range of letters and numbers that can simply be peeled from their backing and applied to the desired surface.

However, one disadvantage of these kits stems from their pre-packaged nature. Because they are not specially manufactured for each user, the kits often contain numbers or letters that do not suit the user's particular needs. This often leads to inconvenience and waste. For example, after finishing a desired project, the user may be left with several excess letters or numbers that are of little use because they do not spell complete words. These left-over pieces are usually discarded. On the other hand, the kits may not contain enough of the particular letters or numbers that the user needs to complete the project. It is often necessary in this case for the user to buy an additional kit even though he or she does not need the majority of the letters or numbers in the package.

Accordingly, alternatives to the die-cut number and letter sheets, such as customized kits and individually-sold letters and numbers, have been developed to overcome these disadvantages. However, these alternatives have their own shortcomings. While purchasing individual letters and numbers or a kit customized to fit one's needs may reduce waste, both of these alternatives are more expensive than the pre-packaged kits. Additionally, as is the case with the entire body of prior art products, the user still may need to purchase additional numbers or letters if he or she makes a mistake or decides to alter the project after purchasing the materials.

Therefore, what is desired is to provide a convenient and affordable lettering and numbering kit that is versatile enough to adapt to the user's individual needs. One prior art kit attempts to achieve this objective by providing several identical character segments which can be arranged in such a way to form digital-like letters and numbers. However, one shortcoming of such a kit is that standard digital numbers and letters are often difficult to read. By providing a kit having only many identical segments, the user is unable to make diagonal lines and is constrained to forming very boxy letters and numbers. Thus, for readability and stylistic purposes, it is desired that the kit include character segments of at least two different lengths. To further add to the readability of the letters and numbers, it is also desired that the segments be made of a highly visible and conspicuous material.

In most applications, regardless of how they are packaged and sold, it is preferable that the numbers and letters be easily visible and be made of high-quality, durable materials. For example, in the case of house signs, it is preferable to have a product which will sufficiently and reliably identify the address numbers, no matter what time of day. Clearly displayed house or building numbers can help delivery drivers, taxis and visitors find their destination more easily. More importantly, in emergency situations, the visibility of a house number can greatly effect the time in which it takes for emergency personnel to find one's home.

Some materials, such as reflective or glow materials, are useful in achieving this goal. Using reflective or glow numbers to display one's house or business address can greatly increase visibility, especially in low-light conditions. It is, therefore, desirable to provide a kit for constructing reflective, glow, fluorescent, bold color, holographic, glow/reflective, fluorescent/reflective, bold color/reflective, or holographic/reflective letters and numbers.

### SUMMARY

Accordingly, it is an object of the present invention to provide a convenient and versatile lettering and numbering kit that produces less waste than conventional kits.

It is a further object of the present invention to provide a lettering and numbering kit that is easy to use and easy to apply to a desired surface.

It is a further object of the present invention to promote the visibility of the resulting letters and numbers by providing a kit of reflective, glow, fluorescent, bold color, holographic, glow/reflective, fluorescent/reflective, bold color/reflective, or holographic/reflective segments.

These and other objects and advantages are achieved, in one aspect, by providing a sheet of detachable character segments. A plurality of seams arranged on the sheet defines the character segments, which can be detached from the sheet upon applying an external force along the seams. The kit includes character segments of two lengths. At least some of the character segments form a plurality of characters when positioned in a plurality of formations which correspond to every number from zero to nine and every letter of the alphabet.

In one embodiment, the character segments have at least six edges. In another embodiment, the character segments are generally rectangular shapes with beveled ends. In yet another embodiment of the present invention, the character segments have a first end and a second end, each having two edges connected so as to define an acute angle, connected by two opposing, generally parallel edges. In yet another embodiment, the character segments have four edges and are rectangular.

The sheet includes, in one embodiment, a first layer of material that is vinyl, thermoplastic, metal, wood, glass, plastic, or ceramic. In another embodiment, the sheet also includes a second layer which can be made of reflective material, glow material, fluorescent material, bold color material, holographic material, glow/reflective material, fluorescent/reflective material, bold color/reflective material, or holographic/reflective material. Additionally, in yet another embodiment, the sheet also includes an attachment layer which can be a pressure sensitive adhesive backing, a heat application adhesive backing, and a magnetic backing. For example, the segments can be made of metal such as anodized aluminum, with or without an adhesive backing.

In another aspect of the present invention, a lettering and numbering kit including a sheet having a first layer, a reflective layer, and an attachment layer and having a plurality of seams arranged to define a plurality of reflective character segments having at least four edges. Each of the character segments is detachable from the sheet along a respective one of the seams, upon applying an external force. In this embodiment, the kit includes character segments of two different lengths that form a plurality of characters when positioned in a plurality of formations corresponding to every number from zero to nine and every letter of the alphabet.

In yet another aspect of the present invention, a lettering and numbering kit including a plurality of individual character segments is provided. The kit includes character segments of two different lengths that can form a plurality of characters when positioned in a plurality of formations, the plurality of formations corresponding to every number from zero to nine and every letter of the alphabet.

In another aspect of the present invention, a character formed from at least one short character segment and at least one long character segment, wherein the at least one short character segment and the at least one long character segment are positioned in at least one formation is provided. This formation can include any number from zero to nine and any letter of the alphabet. The at least one short character segment and at least one long character segment also have a first layer of material, which can be vinyl or thermoplastic, and an attachment layer, which can be adhesive or a magnet.

The present invention, in yet another aspect, includes a method of forming a character. The method includes the steps of providing a sheet having a plurality of seams arranged to define a plurality of short character segments and a plurality of long character segments, detaching at least one short character segment and at least one long character segment from the sheet along at least one of the seams by applying an external force, and positioning the at least one character segment in at least one formation. This formation can include any number from zero to nine and any letter of the alphabet.

The sheet includes character segments having two different lengths. In other optional embodiments, the sheet can also include a first layer of vinyl, thermoplastic, metal, wood, glass, plastic, or ceramic material, a second layer of reflective, glow, fluorescent, bold color, holographic, glow/reflective, fluorescent/reflective, bold color/reflective, or holographic/reflective material, and an attachment layer. In another embodiment, the method also includes the step of attaching the at least one short character segment and at least one long character segment in at least one formation to a surface

Other objects, features and advantages according to the present invention will become apparent from the following detailed description of several embodiments of the invention as described in conjunction with the drawings.

### BRIEF DESCRIPTION OF THE DRAWINGS

FIG. 1 is a top view of one embodiment a lettering and numbering kit, showing a sheet of character segments of two different lengths.

FIG. 2 illustrates how the character segments can be used to form letters and numbers.

FIG. 3 is a side view of a lettering and numbering kit, showing a first layer, a second layer and an attachment layer.

FIG. 4 is a top view of one embodiment of a lettering and numbering kit, showing a plurality of individual character segments of two different lengths.

### DETAILED DESCRIPTION OF THE DRAWINGS

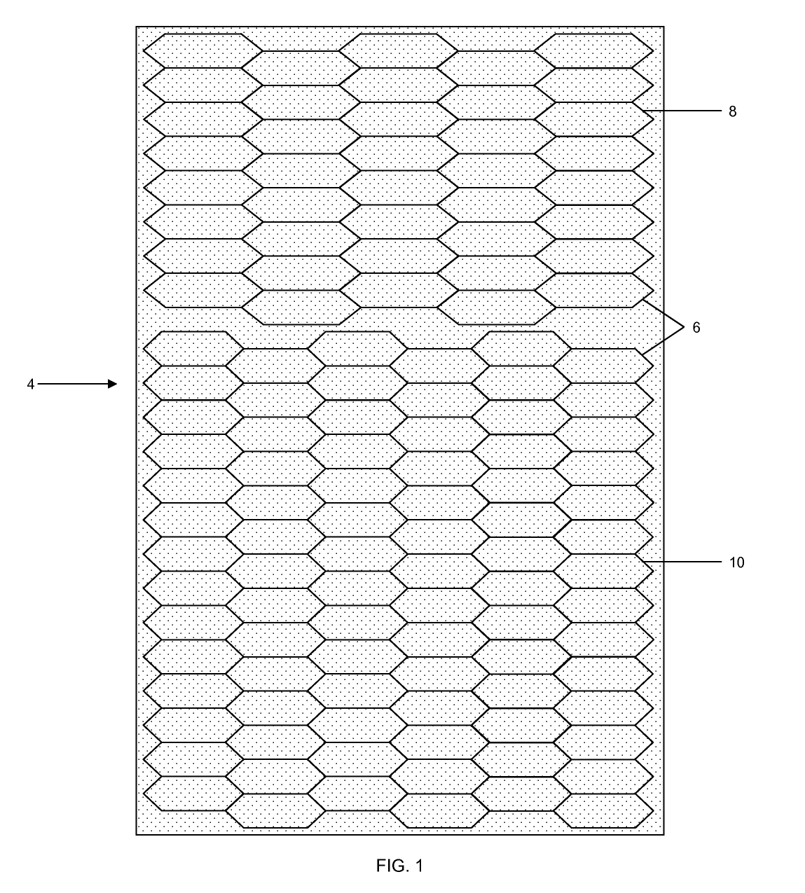

Referring to FIG. 1, a lettering and numbering kit 4 in accordance with the present invention is shown. The lettering and numbering kit 4 includes a plurality of character segments 6.

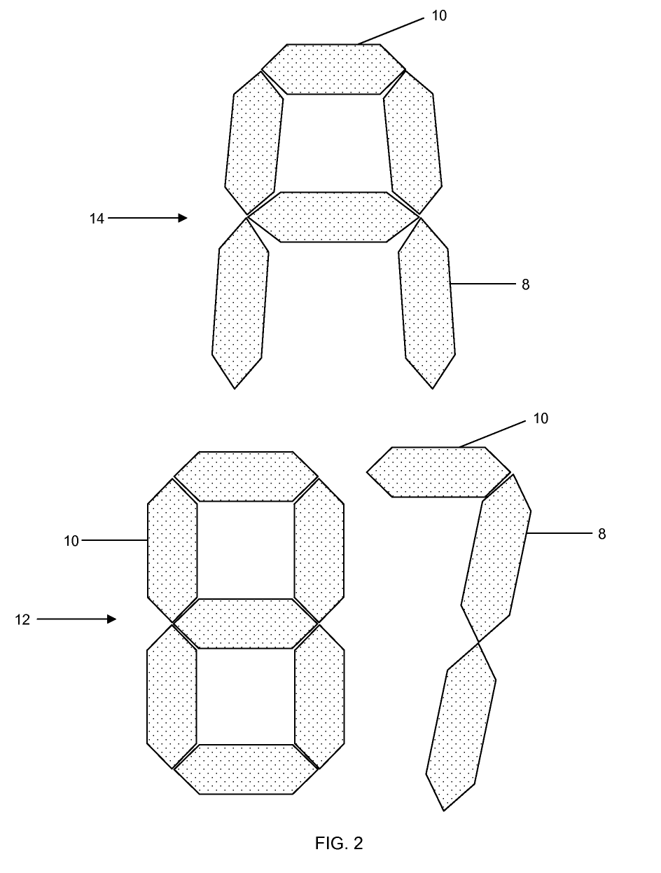

As shown in FIG. 2, the character segments 6 are shaped so as to form digital-like numbers 12 and letters 14 when used in combination. For example, seven segments, some placed horizontally and some vertically, can be arranged so as to form the number eight. While in the present embodiment, the character segments 6 are six-sided shapes resembling rectangles with beveled ends or elongated hexagons, other shapes could be used and are within the knowledge of one skilled in the art. These bevels allow the segments 6 to come together at close-fitting joints.

Additionally, the present embodiment of the lettering and numbering kit 4 includes both long 8 and short 10 length character segments 6. The long length 8 segments allow the user to create diagonal lines, as demonstrated by the number “7” and the letter “A” shown in FIG. 2. Because of these long segments 8, the user is not constricted to the boxy look of standard digital letters and numbers. This can greatly increase the readability of the letters and numbers and is a significant advantage of the present invention.

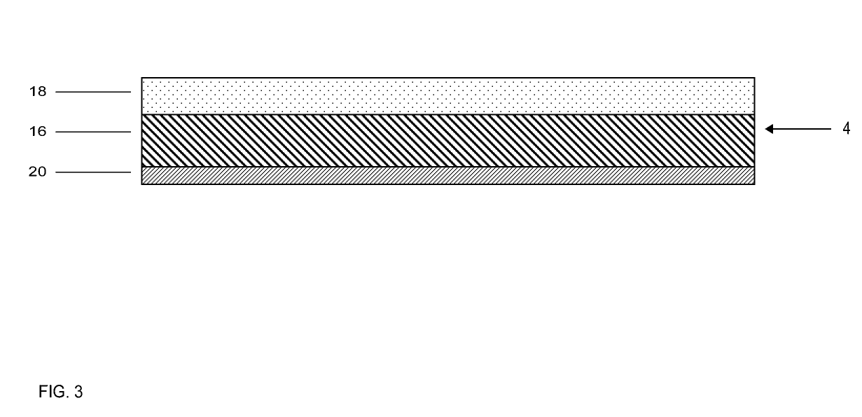

The lettering and numbering kit 4 can be made of a variety of materials and can be presented in a variety of forms. As shown in FIG. 1, one embodiment of the kit 4 takes the form of a sheet of detachable character segments 6. The character segments 6 are defined by a plurality of seams which have been kiss-cut or die-cut into the sheet and can be detached for use by applying an external force at the seams. In the present embodiment, the sheet includes a first layer 16 of a flexible material, such as vinyl or thermoplastic. The sheet can also include a second layer 18 of reflective, glow, fluorescent, bold color, holographic, glow/reflective, fluorescent/reflective, bold color/reflective, or holographic/reflective material for increasing the visibility of the resulting letters and/or numbers. This can be seen in FIG. 3.

Furthermore, the kit can also include an attachment layer 20 for applying or attaching the segments to a variety of surfaces. In the present embodiment, the segments 6 have a self-adhesive layer and can simply be peeled from the backing and applied to the desired surface. The segments 6 could instead be equipped with a thin magnetic layer for being temporarily applied to a metal surface, such as a car or boat. Other means for applying or attaching the segments to a desired surface, such as heat application or gluing, are contemplated and are within the knowledge of one skilled in the art.

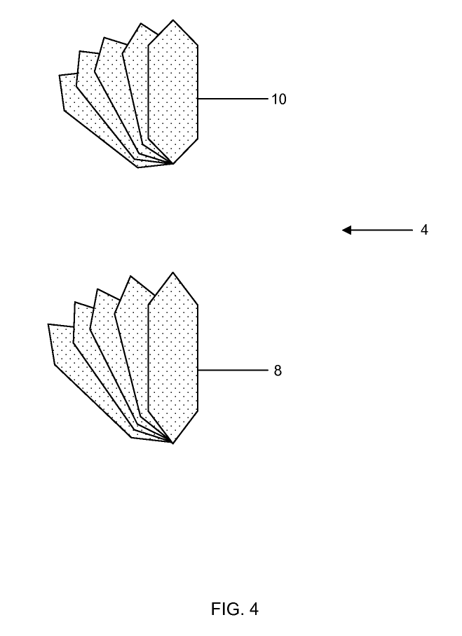

The lettering and numbering kit 4 could be presented in another embodiment as a set of individual character segments. In this alternate embodiment, shown in FIG. 4, the character segments could be pre-cut from a flexible material, such as vinyl or thermoplastic. For more rigidity, the segments could also be made from wood, metal, glass, ceramics, or injection-molded plastic. The individual segments can be equipped with a layer of adhesive or magnetic material, or could have pre-drilled holes for securing the segments to a desired surface with decorative nails or screws. Additionally, these individual character segments could be furnished with a layer of reflective, glow, fluorescent, bold color, holographic, glow/reflective, fluorescent/reflective, bold color/reflective, or holographic/reflective material.

Overall, the character segments 6 of the present invention allow the user to create an array of letters and numbers without being constrained to a particular set of pre-formed letters and numbers as provided in the pre-packaged kits known in the prior art. However, because the kit can be packaged, either as a sheet with detachable character segments, or as multiple individual segments, the present invention retains the convenience and affordability of the conventional lettering and numbering kits. By additionally including character segments 6 of two lengths in the kits, the user can modify the standard digital letters and numbers for a more readable look. Thus, the versatility of the character segments constitutes a great improvement over the prior art.

Although the invention has been described with reference to a particular arrangement of parts, features and the like, these are not intended to exhaust all possible arrangements or features, and indeed many modifications and variations will be ascertainable to those of skill in the art.

What is claimed is:

1. A numbering and lettering kit comprising:
a sheet having a plurality of seams arranged to define a plurality of character segments, each character segment being detachable from the sheet along at least one of the seams upon applying an external force;
said plurality of segments including a first plurality of character segments having a first length and a second plurality of character segments having a second length different than the first length;
wherein at least some of said character segments form a plurality of characters when positioned in a plurality of formations, the plurality of formations corresponding to every number from 0-9 and every letter of the alphabet.

2. The numbering and lettering kit of claim 1 wherein each of said character segments has six edges.

3. The numbering and lettering kit of claim 2 wherein each of said character segments is a generally rectangular shape with beveled ends.

4. The numbering and lettering kit of claim 2 wherein each of said character segments has a first and a second end, each having two edges connected so as to define an acute angle;
said first end and second end are connected by two opposing, generally parallel edges defining the body of the segment, wherein said generally parallel edges are longer than those edges of the first and second ends.

5. The numbering and lettering kit of claim 1 wherein each of said character segments has four edges and is rectangular.

6. The numbering and lettering kit of claim 1 wherein said sheet has a first layer of material chosen from the group consisting of: vinyl and thermoplastic.

7. The numbering and lettering kit of claim 6 wherein said sheet further includes a second layer chosen from the group consisting of: reflective material, glow/reflect material, glow material, and holographic material.

8. The numbering and lettering kit of claim 7 wherein said sheet further includes an attachment layer chosen from the group consisting of: a pressure sensitive adhesive backing, a heat application adhesive backing, and a magnetic backing.

9. The numbering and lettering kit of claim 1 wherein said sheet has a first layer of material chosen from the group consisting of: metal, wood, glass, plastic, and ceramic.

10. The numbering and lettering kit of claim 9 wherein said sheet further includes an attachment layer chosen from the group consisting of: an adhesive backing and a magnetic backing.

11. A numbering and lettering kit comprising:
a sheet including a first layer, a reflective layer and an attachment layer, said sheet having a plurality of seams arranged to define a plurality of character segments, each character segment having at least four edges and being detachable from the sheet along at least one of the seams upon applying an external force;
said plurality of segments including a first plurality of character segments having a first length and a second plurality of character segments having a second length different than the first length;
wherein at least some of said character segments form a plurality of characters when positioned in a plurality of formations, the plurality of formations corresponding to every number from 0-9 and every letter of the alphabet.

12. The numbering and lettering kit of claim 11 wherein each of said character segments has six edges.

13. The numbering and lettering kit of claim 12 wherein each of said character segments is a generally rectangular shape with beveled ends.

14. The numbering and lettering kit of claim 12 wherein each of said character segments has a first and a second end, each comprising two connecting edges defining an acute angle;
said first end and second end are connected by two opposing, generally parallel edges defining the body of the segment, wherein said generally parallel edges are longer than those edges of the first and second ends.

15. The numbering and lettering kit of claim 11 wherein said first layer is chosen from the group consisting of: vinyl and thermoplastic.

16. The numbering and lettering kit of claim 11 wherein said attachment layer is chosen from the group consisting of: a pressure sensitive adhesive backing, a heat application adhesive backing, and a magnetic backing.

17. A numbering and lettering kit comprising:
a plurality of character segments including a first plurality of character segments having a first length and a second plurality of character segments having a second length different than the first length;
wherein at least some of said character segments form a plurality of characters when positioned in a plurality of formations, the plurality of formations corresponding to every number from 0-9 and every letter of the alphabet.

18. The numbering and lettering kit of claim 17 wherein each of said character segments has at least six edges.

19. The numbering and lettering kit of claim 18 wherein each of said character segments is a generally rectangular shape with beveled ends.

20. The numbering and lettering kit of claim 18 wherein each of said character segments has a first and a second end, each comprising two connecting edges defining an acute angle;
said first end and second end are connected by two opposing, generally parallel edges defining the body of the segment, wherein said generally parallel edges are longer than those edges of the first and second ends.

21. The numbering and lettering kit of claim 17 wherein each of said character segments has four edges and is rectangular.

22. The numbering and lettering kit of claim 17 wherein said character segments have a first layer of material chosen from the group consisting of: vinyl, thermoplastic, plastic, wood, glass, ceramic, and metal.

23. The numbering and lettering kit of claim 17 wherein said character segments have a second layer chosen from the group consisting of: reflective, glow, fluorescent, bold color, holographic, glow/reflective, fluorescent/reflective, bold color/reflective, and holographic/reflective material.

24. The numbering and lettering kit of claim 17 wherein said character segments have an attachment layer chosen from the group consisting of: an adhesive backing and a magnetic backing.

25. A character formed from at least one short character segment and at least one long character segment;
said at least one short character segment and said at least one long character segment having a first layer of material and an attachment layer;
wherein said at least one short character segment and at least one long character segment are positioned in at least one formation, said at least one formation chosen from the group consisting of: every number from 0-9 and every letter of the alphabet.

26. The numbering and lettering kit of claim 25 wherein said first layer of material is chosen from the group consisting of: vinyl, thermoplastic, plastic, wood, glass, ceramic, and metal.

27. The numbering and lettering kit of claim 25 wherein said attachment layer is chosen from the group consisting of: a pressure sensitive adhesive backing, a heat application adhesive backing, and a magnetic backing.

28. The numbering and lettering kit of claim 25 wherein said at least one short character segment and said at least one long character segment have a second layer chosen from the group consisting of: reflective material, glow/reflect material, glow material, fluorescent material, bold color material, and holographic material.

29. The numbering and lettering kit of claim 25 wherein said at least one short character segment and said at least one long character segment have six edges.

30. The numbering and lettering kit of claim 25 wherein said at least one short character segment and said at least one long character segment have four edges.

31. A method of forming a character comprising the steps of:
providing a sheet having a plurality of seams arranged to define a plurality of character segments, said plurality of segments including a first plurality of character segments having a first length and a second plurality of character segments having a second length different than the first length;
detaching at least one short character segment and at least one long character segment from the sheet along at least one of the seams by applying an external force; and
positioning said at least one short character segment and said at least one long character segment in at least one formation, said formation chosen from the group consisting of: every number from 0-9 and every letter of the alphabet.

32. The method of claim 31 wherein said sheet further includes a first layer of material chosen from the group consisting of: vinyl, thermoplastic, metal, wood, glass, plastic, and ceramic.

33. The method of claim 31 wherein said sheet further includes a second layer chosen from the group consisting of: reflective, glow, fluorescent, bold color, holographic, glow/reflective, fluorescent/reflective, bold color/reflective, and holographic/reflective material.

34. The method of claim 31 wherein said sheet further includes an attachment layer chosen from the group consisting of: a pressure sensitive adhesive backing, a heat application adhesive backing, and a magnetic backing.

35. The method of claim 34 further comprising the step of attaching said at least one character segment in said at least one formation to a surface.
